(19) United States
(12) Patent Application Publication
(10) Pub. No.: US 2025/0329826 A1
(43) Pub. Date: Oct. 23, 2025

(54) ELECTROCHEMICAL CELL WITH ELECTROLYTE MANAGEMENT

(71) Applicant: e-Zinc Inc., Mississauga (CA)

(72) Inventors: Petrus Theodorus DE KONING, Toronto (CA); Nenad IVANOVICH, Brampton (CA)

(73) Assignee: e-Zinc Inc., Mississauga, ON (CA)

(21) Appl. No.: 18/870,511

(22) PCT Filed: Jun. 7, 2023
(86) PCT No.: PCT/CA2023/050775

§ 371 Date: Nov. 29, 2024

Related U.S. Application Data
(60) Provisional application No. 63/354,726, filed on Jun. 23, 2022.

(51) Int. Cl. H01M 12/02; H01M 12/08; H01M 50/138

(52) U.S. Cl. CPC H01M 12/02; H01M 12/08; H01M 50/1385

(57) ABSTRACT

A cathode assembly for an electrochemical cell has an air cathode and an air cathode subassembly. The air cathode subassembly houses a gaseous oxygen cathode material in a gas volume. The air cathode subassembly includes a frame bounding edges of the gas volume, a floor bounding a first face of the gas volume, at least one recirculation outlet and a plurality of internal fluid conduits in the frame configured to collect fluid from outside the gas volume along edges of the air cathode to direct the collected liquid electrolyte to the at least one recirculation outlet through which the liquid electrolyte exits the air cathode subassembly. The air cathode is secured to the frame to bound a second face of the gas volume. In an electrochemical cell, the air cathode may be oriented at an angle of 45° or less with respect to horizontal.

### CROSS-REFERENCE TO RELATED APPLICATIONS

This application claims the benefit of United States Provisional patent application U.S. Ser. No. 63/354,726 filed Jun. 23, 2022, the entire contents of which is herein incorporated by reference.

### FIELD

This application relates to electrochemical cells.

### BACKGROUND

Typical charge/discharge type electrochemical cells comprise a tank containing a reservoir of liquid electrolyte in which electrodes (cathodes and anodes) are situated, the tank housing a discharging section generally located at or near a bottom of the tank and a charging section generally located at or near a top of the tank, with a storage section for liquid electrolyte located in between the charging and discharging sections. The charging section operates to store electrical energy in the electrochemical cell and the discharging section operates to deliver the stored electrical energy to operate an electrical device. The charging and discharging sections are generally not operated at the same time.

Charge/discharge type electrochemical cells typically utilize Zn/Zn²⁺ half-cell reactions in a basic aqueous electrolyte. The charging section comprises charge anodes and charge cathodes at which the following chemical reactions occur during a charging operation:

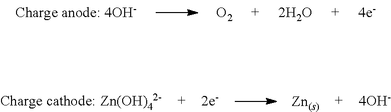

The discharging section comprises discharge anodes and discharge cathodes at which the following chemical reactions occur during a discharging operation:

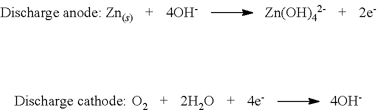

Elemental zinc solid formed at the charge cathode falls to the bottom of the electrochemical cell under the influence of gravity to collect on a metal current collector, which carries current to operate electrical devices when the solid zinc is converted back to Zn(OH)₄²⁻ during the discharging operation of the electrochemical cell.

The discharge cathodes are typically vertically oriented in the tank. A bed of zinc solid builds up around the discharge cathodes during the charging operation and is depleted from around the discharge cathodes during the discharging operation. There are a number of problems with this arrangement. Zinc bed depletion from around the discharge cathodes increases the distance between the discharge cathode and the zinc and therefore reduces cell efficiency and shortens the life of the discharge cathode especially when the discharge cathode is an air cathode. The vertically oriented discharge cathodes act as baffles to prevent side-to-side movement of the solid zinc and the electrolyte in the cell during the discharging operation causing differential depletion of the zinc bed. The differential depletion of the zinc bed is also exacerbated by varying discharge cathode performance in the vertical discharge cathode orientation which inherently depletes zinc within the zinc bed at different rates. An additional consequence of the above is the formation of differential concentrations of zinc salt in different regions of the electrolyte in the cell thereby causing voltage differentials at each discharge cathode, worsening the differential depletion of zinc problem. In another problem associated with vertical discharge cathodes, during the charging operation, solid zinc is inhibited from falling down to the bottom of the cell by the discharge cathodes with some solid zinc accumulating on upper edges of the vertically oriented discharge cathodes, which are not electrochemically active portions of the discharge cathodes. All of these problems lead to inefficient zinc usage and unreacted solid zinc during the discharging operation.

Recirculation of the electrolyte is an important feature of electrochemical cells containing an electrolyte, especially cells in which the liquid electrolyte is susceptible to the formation of concentration gradients. If recirculation is inadequate, passivation of components and undesirable side reactions can occur.

There remains a need for an electrochemical cell design and a discharge cathode therefor, which more efficiently utilizes solid zinc and more efficiently manages liquid electrolyte during the discharging operation.

### SUMMARY

An electrochemical cell is provided having a discharge cathode that is substantially horizontally oriented so that a bed of solid zinc settles above the discharge cathode, not beside the discharge cathodes, during a charging operation to cover the entire discharge cathode. During a discharging operation, the zinc bed is depleted but substantially the entire surface of the discharge cathode remains covered with the zinc bed throughout the discharging operation because the zinc is depleted from the bottom and depleted zinc is continuously replaced by more zinc in the bed by the action of gravity. Thus, gravity keeps the zinc bed (i.e., the anode) evenly distributed over the anode current collector and over the discharge cathode.

Further, the discharge cathode design permits greater modularity of the electrochemical cell allowing for the storage section to be separable from the discharging section.

Furthermore, the discharge cathode design permits utilization of a series of recirculation inlets along a length of the cell in fluid communication with a plurality of internal fluid conduits to recycle liquid electrolyte in a more uniform manner throughout the cell. In this regard, the discharge cathode design is also useful in configurations where the discharge cathode is not substantially horizontally oriented, but the design is particularly useful in electrochemical cells where the discharge cathode and the separator are closely spaced and liquid electrolyte is recirculated from a region between the separator and the discharge cathode and to a region of the cell outside a region between the separator and the discharge cathode, for example to a top of a reservoir of the liquid electrolyte.

A cathode assembly for an electrochemical cell is provided, the cathode assembly comprising: an air cathode subassembly configured to house a gaseous oxygen (O₂) cathode material in a gas volume, the air cathode subassembly comprising: a frame bounding edges of the gas volume; a floor bounding a first face of the gas volume; at least one recirculation outlet in the air cathode subassembly; and, a plurality of internal fluid conduits contained in the frame configured to collect liquid electrolyte from outside the gas volume to direct the collected liquid electrolyte to the at least one recirculation outlet through which the liquid electrolyte exits the air cathode subassembly; and, an air cathode secured to the frame to bound a second face of the gas volume, the plurality of internal fluid conduits configured to collect the liquid electrolyte along edges of the air cathode.

The cathode assembly is useful in any type of electrochemical cell. When used in a charge/discharge type electrochemical cell, the cathode assembly is a discharge cathode assembly.

An electrochemical cell is provided that comprises: an anode comprising a solid anode material; a liquid electrolyte in physical contact with the solid anode material; an air cathode comprising a gaseous oxygen (O₂) cathode material, the air cathode oriented at an angle of 45° or less with respect to horizontal when in use in the cell; an air cathode subassembly configured to house the gaseous oxygen in a gas volume, the air cathode sealingly mounted in the air cathode subassembly and separating the gas volume from the liquid electrolyte above the gas volume, the gaseous oxygen capable of diffusing out of the gas volume into an interface region of the air cathode where the gaseous oxygen contacts the liquid electrolyte; a separator comprising an electrically insulating material, the separator separating the air cathode from the anode material, the separator permeable to the liquid electrolyte, the separator impermeable to the solid anode material; and, an electrolyte management subsystem comprising at least one fluid conduit that collects the liquid electrolyte from between the air cathode and the separator and recirculates the collected electrolyte to the liquid electrolyte above the separator.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a perspective view of an electrochemical cell.

FIG. 2 depicts a side cross-section view of the electrochemical cell of FIG. 1.

FIG. 3 depicts a rear cross-section view through a rear rain head of the electrochemical cell of FIG. 1.

FIG. 4 depicts a front isometric perspective view of a discharge section of the electrochemical cell of FIG. 1.

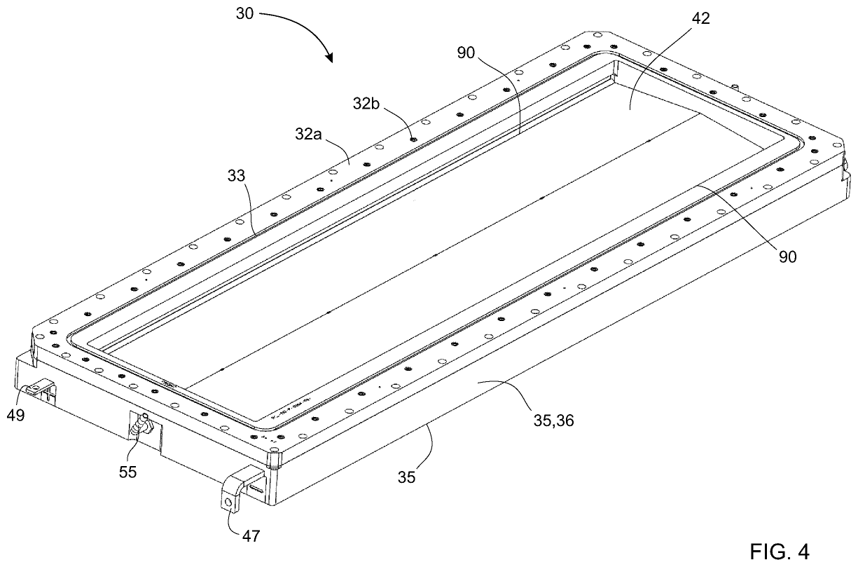

FIG. 5 depicts a front isometric perspective view of the discharge section of FIG. 4 with an anode current collector, separator, the flange, and air cathode removed.

FIG. 6 depicts a rear isometric perspective view of the discharge section of FIG. 4 with various layers partially removed to illustrate relationships between layers.

FIG. 7 depicts a simplified top view of the discharge section of FIG. 4 with various layers partially removed to illustrate relationships between layers.

FIG. 8 depicts a simplified view of FIG. 3 with various elements removed.

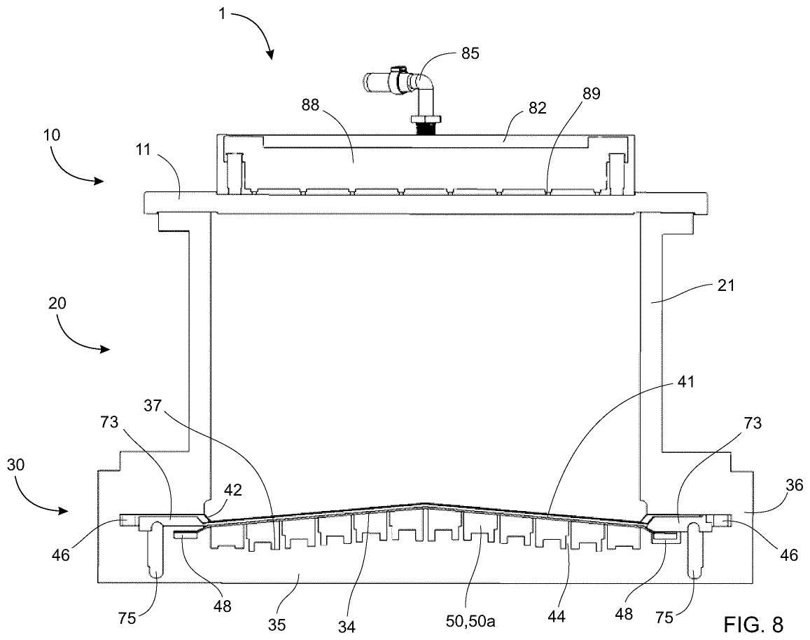

FIG. 9 depicts a magnified view of one side of the view depicted in FIG. 8.

FIG. 10 depicts a simplified schematic of FIG. 2 with various elements removed showing how air is supplied to a gas volume of an air cathode subassembly.

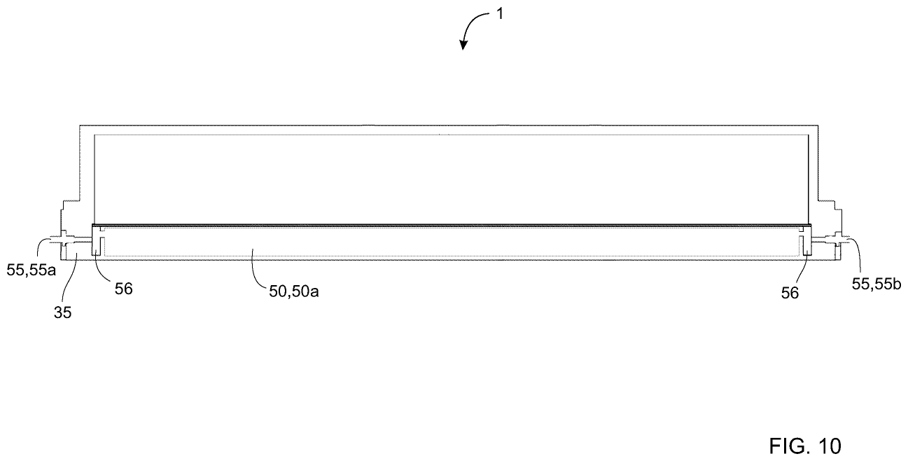

FIG. 11 depicts a magnified view of one side of the view depicted in FIG. 10.

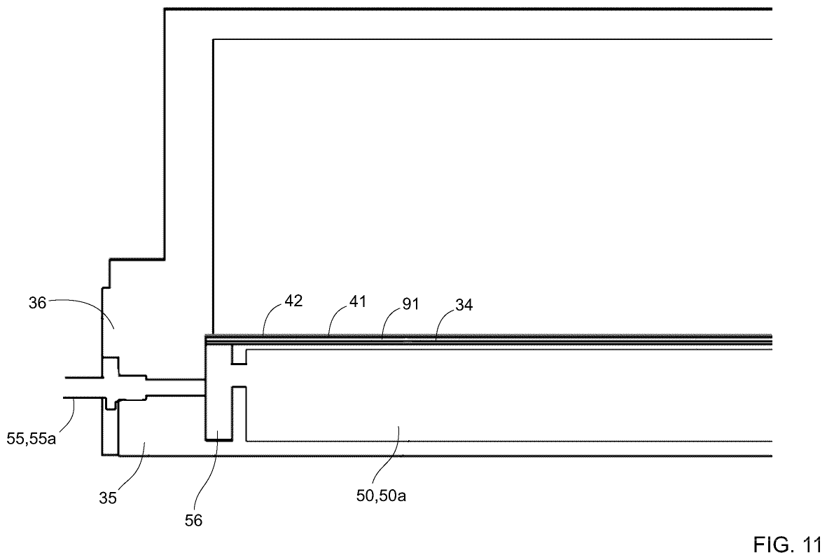

FIG. 12 depicts a perspective view of recirculation conduits in a base of the discharge section of FIG. 4.

FIG. 13 depicts a magnified view of a portion of a central portion of FIG. 12.

FIG. 14 depicts a top view of a base of the discharge section of FIG. 4 with an anode current collector, separator and air cathode removed.

### DETAILED DESCRIPTION

As used herein, an anode material is a chemical species that is oxidized (i.e., loses electrons) in a half-cell reaction. The anode material in the discharge section of the electrochemical cell preferably comprises a metal, for example metallic zinc, copper, lead or the like. The anode material is more preferably zinc metal. The anode material is preferably particulate, forming a bed of anode material particles above the separator. The bed of anode material particles is porous to permit flow of liquid electrolyte through the bed to the separator.

As used herein, an anode is a physical structure that comprises the anode material and is where an anodic half-cell reaction involving the anode material occurs. In the discharge section of the electrochemical cell, the anode comprises the bed of the anode material. The bed of the anode material preferably covers the separator.

As used herein, an anode current collector is a physical structure that comprises a conductive material used to transport electrons from the anode material. The electrochemical cell preferably comprises an anode current collector situated below and in physical contact with the anode material. The anode current collector is preferably a porous conductive metal mesh. The metal preferably comprises nickel or copper.

As used herein, a cathode material is a chemical species that is reduced (i.e., gains electrons) in a half-cell reaction. The cathode material in the discharge section of the electrochemical cell preferably comprises an oxidizing gas, preferably gaseous oxygen. The gaseous oxygen is preferably provided as air, more preferably as air which has been scrubbed of carbon dioxide.

As used herein, a cathode is a physical structure where a cathodic half-cell reaction involving the cathode material occurs. Where the cathode material is an oxidizing gas (e.g., gaseous oxygen), the cathode material resides in the cathode immediately before reacting and is continuously replenished in the cathode as the cathode material reacts.

As used herein, a cathode current collector is a physical structure that comprises a conductive material used to transport electrons to the cathode material. The cathode current collector is preferably a porous metal mesh. The metal preferably comprises nickel or copper.

As used herein, an air cathode is a cathode comprising the cathode current collector and an active layer containing an electrochemically active catalyst for the cathodic half-cell reaction. The catalyst is preferably disposed within the active layer together with conductive carbon and a binder, preferably a hydrophobic binder (e.g., polytetrafluoroethylene (PTFE)). Preferably, the active layer is laminated to the cathode current collector. In some embodiments, the air cathode also comprises a backing layer of a hydrophobic material (e.g., PTFE or a mixture of PTFE and conductive carbon). The air cathode comprises an interface region in which the catalyst is situated. In the interface region, the liquid electrolyte and the gaseous oxygen contact each other and the cathodic half-cell reaction occurs. Thus, the liquid electrolyte, the catalyst and the gaseous oxygen form a triple phase boundary at the interface region where the gaseous oxygen reacts to form hydroxide ions.

As used herein, a separator is a physical structure that comprises a porous electrically insulating material. The separator electrically separates the cathode from the anode material. The separator preferably covers the cathode to prevent anode material from directly contacting the cathode. The separator preferably has a perimeter that is perimetrically sealed to the housing to prevent the solid anode material from entering the electrolyte management subsystem and so that the liquid electrolyte must permeate through the separator to reach the interface region. The separator is permeable to the liquid electrolyte but impermeable to the solid anode material. In this regard, the separator also acts as a filter. The separator preferably has a porosity that creates a pressure differential between above and below the separator to encourage more uniform permeation of the liquid electrolyte through the separator toward the cathode across an entire surface area of the separator. The separator preferably comprises a mat of polypropylene fibers. The mat preferably has a density in a range of 20-100 g/m³, for example 60 g/m³. The mat preferably has a thickness in a range of 80 to 300 microns, for example 180 microns. The mat preferably has an air permeability of 100 to 500 dm³/second*m².

As used herein, the liquid electrolyte is a liquid medium containing anions capable of reacting with oxidized anode material to form an anionic metal complex. Preferably, the liquid medium is an aqueous medium. Preferably, the anions are hydroxide ions, which may be present in solution in the aqueous medium, for example by dissolving an alkali metal hydroxide (e.g., NaOH, KOH) in water to form an aqueous solution of hydroxide ions. The hydroxide ions react with metal cations to form metalate complexes when the anode material is oxidized. In a Zn/Zn²⁺ electrochemical cell, the metalate is Zn(OH)₄²⁻ having Na⁺ or K⁺ counterions in the electrolyte solution.

The air cathode is secured to an air cathode subassembly to form a cathode assembly. The air cathode subassembly is preferably configured to house the gaseous oxygen in a gas volume. The air cathode subassembly therefore acts as a storage unit for the gaseous oxygen. The air cathode is preferably sealingly mounted in the air cathode subassembly and separates the gas volume from the liquid electrolyte above the gas volume. The gaseous oxygen diffuses out of the gas volume into the interface region of the air cathode where the gaseous oxygen contacts the liquid electrolyte. The cathode assembly thus preferably comprises a frame bounding edges of the gas volume, a floor bounding a first face of the gas volume and the air cathode secured to the frame to bound a second face of the gas volume. In some embodiments, the air cathode subassembly also comprises a base defining the floor and the frame, and the cathode assembly comprises a flange removably connected to a top of the base. The flange may be configured to support walls for containing liquid electrolyte in the electrochemical cell.

In some embodiments, the air cathode subassembly comprises a plurality of bridges situated in the gas volume to support the air cathode thereon. In some embodiments, the air cathode subassembly comprises at least one gas port for introducing the gaseous oxygen into the gas volume. In some embodiments, the air cathode subassembly is configured to sealingly support walls thereon for containing the liquid electrolyte in the electrochemical cell, which in some embodiments is above the separator.

In some embodiments, the air cathode is oriented substantially horizontally, which is to say at an angle of 45° or less with respect to horizontal when the cathode assembly is in use in an electrochemical cell. In these embodiments, the second face of the gas volume, and therefore the air cathode, is above the gas volume, and the first face of the gas volume, and therefore the floor of the air cathode subassembly, is below the gas volume. Preferably, the angle is 20° or less. In some embodiments, the angle is 0°, in which case the air cathode is exactly horizontal. In some embodiments, the angle is in a range of 1-20°. Different portions of the air cathode may be at different angles with respect to horizontal. In some embodiments, the air cathode is peaked to minimize sagging of the air cathode. Likewise, the separator and/or the anode collector may be peaked to minimize sagging of the separator and/or anode collector, and to promote flow of the liquid electrolyte toward outer edges of the separator.

The electrochemical cell comprises an electrolyte management subsystem. The electrolyte management subsystem comprises internal components inside the electrochemical cell and in structural elements of various components of the electrochemical cell, for example charging and discharging sections of a charge/discharge type of electrochemical cell. The electrolyte management subsystem also comprises external components outside the electrochemical cell.

The electrolyte management subsystem comprises internal and external components associated with the air cathode subassembly. In this regard, the air cathode subassembly preferably comprises at least one fluid conduit, preferably a plurality of internal fluid conduits, contained in the frame configured to collect liquid electrolyte from outside the gas volume. The at least one fluid conduit preferably directs the collected liquid electrolyte to at least one recirculation outlet through which the liquid electrolyte exits the air cathode subassembly. Preferably, the at least one fluid conduit comprises a fluid conduit manifold comprising the plurality of internal fluid conduits in fluid communication with the liquid electrolyte between the air cathode and the separator. The plurality of internal fluid conduits preferably has a plurality of recirculation inlets situated between the air cathode and the separator for collecting the liquid electrolyte from along edges of the air cathode outside the gas volume and directing the collected liquid electrolyte to the at least one recirculation outlet through which the liquid electrolyte exits the air cathode subassembly. In some embodiments, the air cathode subassembly comprises at least one drain port. Preferably, the floor is configured to direct liquid electrolyte that leaks into the gas volume toward the at least one drain port.

In some embodiments, the electrolyte management subsystem comprises at least one external fluid conduit in fluid communication with the at least one recirculation outlet. The at least one external fluid conduit is preferably connected to at least one fluid pump operatively for pumping the collected liquid electrolyte through and out of the at least one external fluid conduit into the electrochemical cell at the top of the liquid electrolyte reservoir, preferably above the separator. In some embodiments, the electrolyte management subsystem comprises an external drain conduit connected to the drain port, the external drain conduit preferably connected to the at least one fluid pump for recycling leaked liquid electrolyte into the electrochemical cell at the top of the liquid electrolyte reservoir.

With reference to the Figures, a Zn/Zn²⁺ electrochemical cell 1 comprises an upper charging section 10, a middle storage section 20 and a lower discharging section 30. The electrochemical cell 1 forms a container in which a liquid electrolyte 2 is contained, the same liquid electrolyte 2 being used in both the charging and discharging operations of the cell 1.

The charging section 10 comprises a plurality of charging electrodes (anodes and cathodes) 12 that are attached to and depend downwardly from bus bars (not shown) connected to perimetrical walls 21 of the storage section 20. The charging section 10 is capped by a lid 11 of the electrochemical cell 1. During a charging operation, metallic zinc particles formed at the charge cathodes fall down through the liquid electrolyte 2 to form a bed 5 of solid metallic zinc particles in the discharging section 30. The bed 5 of metallic zinc particles is the discharge anode and the solid metallic zinc is the anode material in the discharging section 30 during the discharging operation.

The storage section 20 comprises the perimetrical walls 21 bounding a volume with an open top and an open bottom. The lid 11 is releasably secured to and sealingly supported on tops of the walls 21. Bottoms of the walls 21 are releasably secured to and sealingly supported on the discharging section 30 thereby forming a container in which a reservoir of the liquid electrolyte 2 is contained within the cell 1, including within the charging section 10, the storage section 20 and the discharging section 30. The storage section 20 can be of any desired height, and can be readily replaced with a storage section of different height. Such an arrangement illustrates how a substantially horizontal discharge cathode assembly 31 located at the bottom of the electrochemical cell 1 contributes to the modularity and reconfigurability of the electrochemical cell 1.

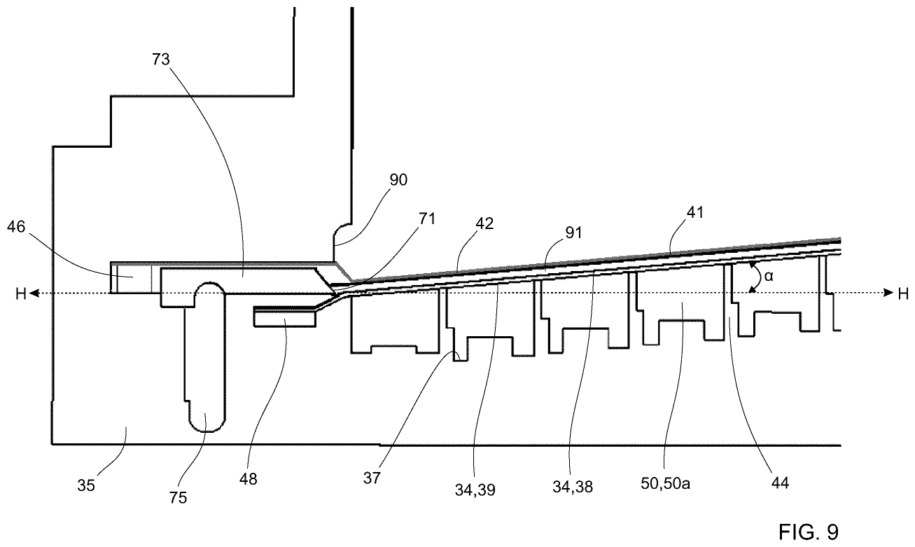

The discharging section 30 comprises a discharge cathode assembly 31 that forms a bottom of the electrochemical cell 1. The discharge cathode assembly 31 comprises an air cathode 34 and an air cathode subassembly 31a comprising base 35, the base 35 having four walls 36 and a floor 37, the walls 36 acting as a frame for the air cathode 34. The floor 37 covers a bottom of the frame and the air cathode 34 covers a top of the frame. The air cathode 34, floor 37 and walls 36 house the gaseous oxygen in a gas volume 50 divided into a series of channels 50a, as described below. The air cathode subassembly 31a further comprises an annular flange 32a sealingly and removably mounted on top of the base 35, for example by bolting the flange 32a to the base 35 through threaded bolt holes 32b in the flange 32a. The flange 32a comprises an annular groove 33 inscribed in a top thereof in which the wall 21 of the storage section 20 is sealingly supported. The discharging section 30 further comprises a separator 41 above and covering the air cathode 34. As shown in FIG. 9 there is a gap 91 between the separator 41 and the air cathode 34. The discharging section 30 further comprises a discharge anode current collector 42 above, in contact with and covering the separator 41. The bed 5 of metallic zinc particles, which is the discharge anode, and therefore the solid metallic zinc, which is the anode material, rests on top of the discharge anode current collector 42.

The air cathode 34 comprises an electrochemically active layer 38 containing a catalyst, the active layer 38 laminated to a discharge cathode current collector 39 as described above. The air cathode 34 is in contact with the gaseous oxygen housed in the gas volume 50 and with the separator 41. The active layer 38 is an interface region for the catalyst, the liquid electrolyte 2 and the gaseous oxygen. In the discharging operation, the liquid electrolyte 2 permeates through the bed 5 of metallic zinc particles (where the discharge anode half-cell reaction occurs), through the discharge anode current collector 42, through the separator 41 and into the air cathode 34 where the liquid electrolyte 2 passes through the discharge cathode current collector 39 and permeates into the active layer 38. The gaseous oxygen diffuses from the gas volume 50 into the air cathode 34 through the discharge cathode current collector 39 into the active layer 38 where the discharge cathode half-cell reaction occurs in the interface region.

The air cathode 34, the separator 41 and the anode current collector 42 are peaked at a peak 43 having raised longitudinal center portions and lower longitudinally-extending outer edges where the air cathode 34, the separator 41 and the anode current collector 42 meet longitudinal inner edges 90 of the frame. The air cathode 34 is oriented at an angle of 45° or less with respect to horizontal H-H when in use in the cell 1, thus an interior angle α (see FIG. 9) between horizontal and the air cathode 34 as the air cathode 34 extends from the outer edges 90 to the peak 43 is 45° or less. The peak 43 helps minimize sagging of the air cathode 34 and the separator 41 due to the weight of the anode material while maintaining the air cathode 34 in a substantially horizontal orientation. In addition, the peak 43 promotes flow of the liquid electrolyte 2 toward the outer edges, which, as described below, facilitates electrolyte recycling.

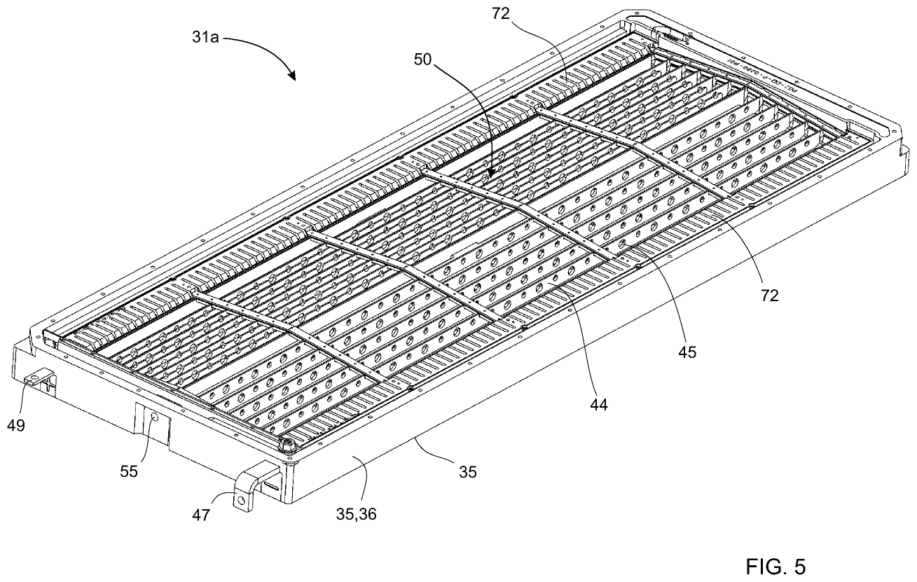

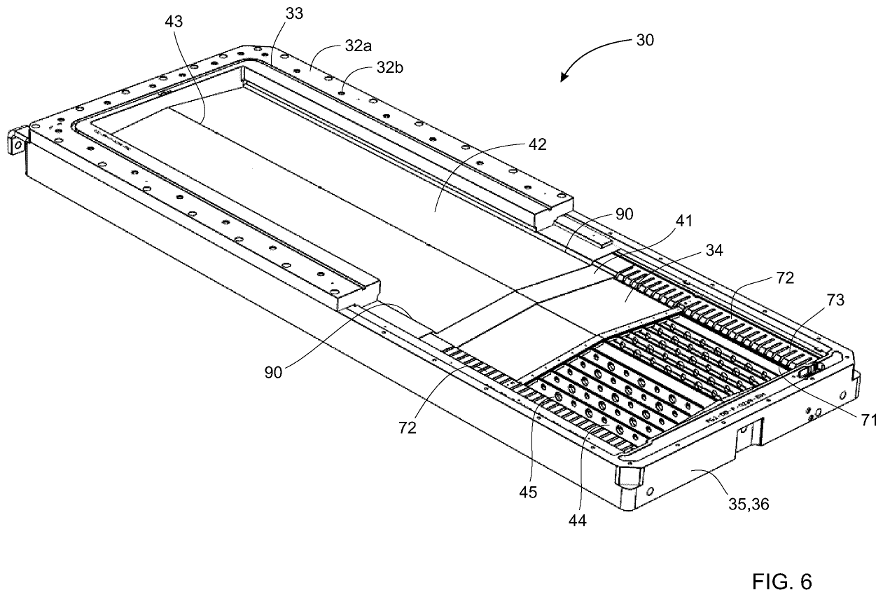

The air cathode 34 is supported in the frame of the base 35 by a plurality of transversely spaced-apart longitudinally-oriented parallel bridges 44 (only one labeled, see FIG. 5 and FIG. 6) situated in the gas volume 50 to support the air cathode 34 thereon. The bridges 44 divide the gas volume 50 into the series of channels 50a. The bridges 44 comprise through apertures 45 (only one labeled, see FIG. 5 and FIG. 6) therein to permit lateral flow of the gaseous oxygen between the channels 50a so that the concentration of gaseous oxygen remains relatively equal throughout the gas volume 50. The gaseous oxygen is introduced in the form of air into the gas volume 50 through an air manifold 56 in the base 35 connected to air ports 55 protruding from the base 35, the air ports comprising an air inlet port 55a and an air outlet port 55b. The air is introduced continuously during the discharge operation to replenish the gaseous oxygen in the gas volume 50 as oxygen is consumed in the discharge cathode half-cell reaction.

The discharge anode current collector 42 is connected to a discharge anode bus bar 46 housed in the base 35, which is electrically connected to a negative terminal 47 of the discharging section 30. The discharge cathode current collector 39 is connected to a discharge cathode bus bar 48 housed in the base 35, which is electrically connected to a positive terminal 49 of the discharging section 30.

The electrochemical cell 1 also comprises an electrolyte management subsystem 70 to recycle the liquid electrolyte 2 in the gap 91, which permeated through the separator 41 and which is enriched in Zn(OH)₄²⁻ due to the discharge anode half-cell reaction, back to the top of the liquid electrolyte 2 reservoir in the cell 1, where the concentration of Zn(OH)₄²⁻ is lower. The electrolyte management subsystem 70 comprises internal components inside the electrochemical cell 1 and in structural elements of the charging section 10 and discharging section 20, and which also comprises external components outside the electrochemical cell 1. The electrolyte management subsystem 70 is purposed to recycle the liquid electrolyte 2 from the bottom of the electrochemical cell 1 to a top of the electrochemical cell 1 so that the liquid electrolyte 2 is as homogeneous as possible.

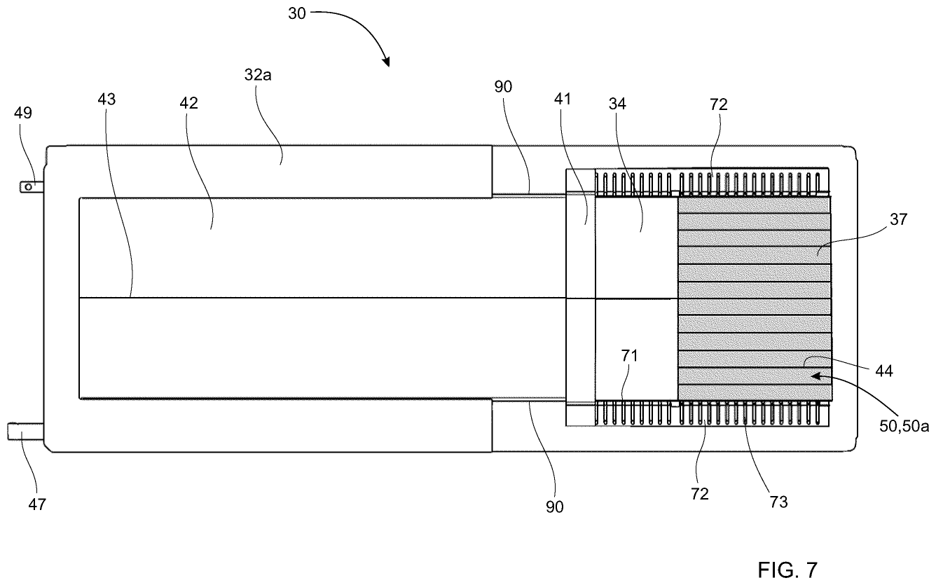

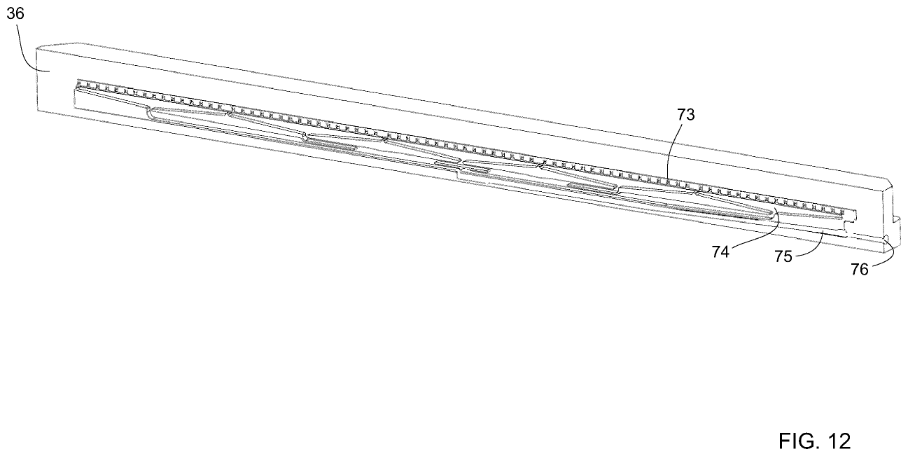

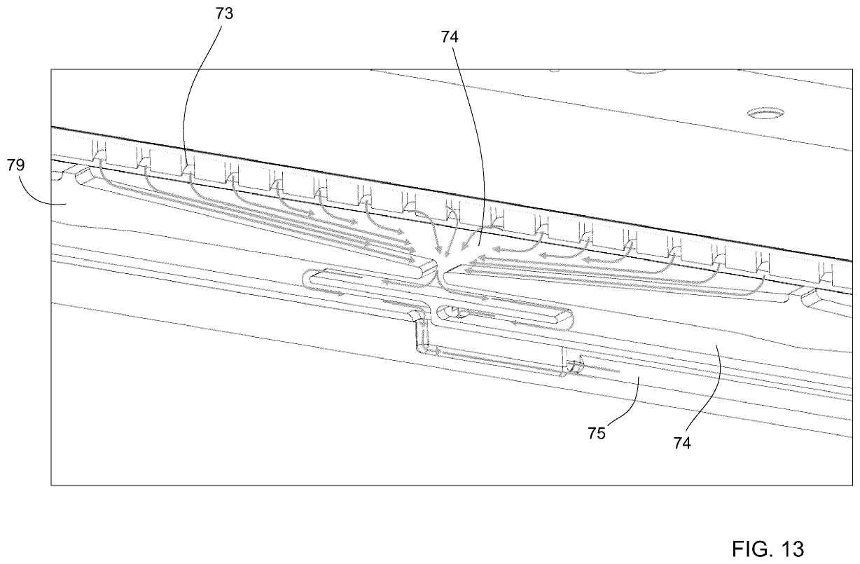

The electrolyte management subsystem 70 comprises at least one fluid conduit that collects the liquid electrolyte 2 from the gap 91 between the air cathode 34 and the separator 41. and that recirculates the collected electrolyte to the liquid electrolyte above the separator 41. To this end, a plurality of fluid intake conduits 73 in the form of recirculation intake combs 72 are a part of a fluid conduit manifold housed within the base 35 of the discharge cathode assembly 31 (see especially FIG. 6, FIG. 7, FIG. 9, FIG. 12 and FIG. 13). The fluid intake conduits 73 have respective recirculation inlets 71 situated along the outer edges of the air cathode 34 and the separator 41 at the gap 91 between the air cathode 34 and the separator 41 for collecting the liquid electrolyte 2 from along the edges of the air cathode 34. The separator 41 has a perimeter that is perimetrically sealed in the base 35 to prevent the solid metal anode material (zinc particles) from entering the electrolyte management subsystem 70 and so that the liquid electrolyte 2 must permeate through the separator 41 to reach the interface region of the air cathode 34. The peak 43 promotes flow of the liquid electrolyte 2 toward the outer edges of the separator 41 and the air cathode 34, and the separator 41 has a porosity that creates a pressure differential between above and below the separator 41 to encourage more uniform permeation of the liquid electrolyte 2 through the separator 41 toward the air cathode 34 across an entire surface area of the separator 41. In this manner, liquid electrolyte 2 is drawn substantially uniformly through the separator 41 across the entire exposed surface area of the separator 41 and is directed evenly toward the outer edges of the air cathode 34 and the separator 41 to be collected by the of recirculation intake combs 72.

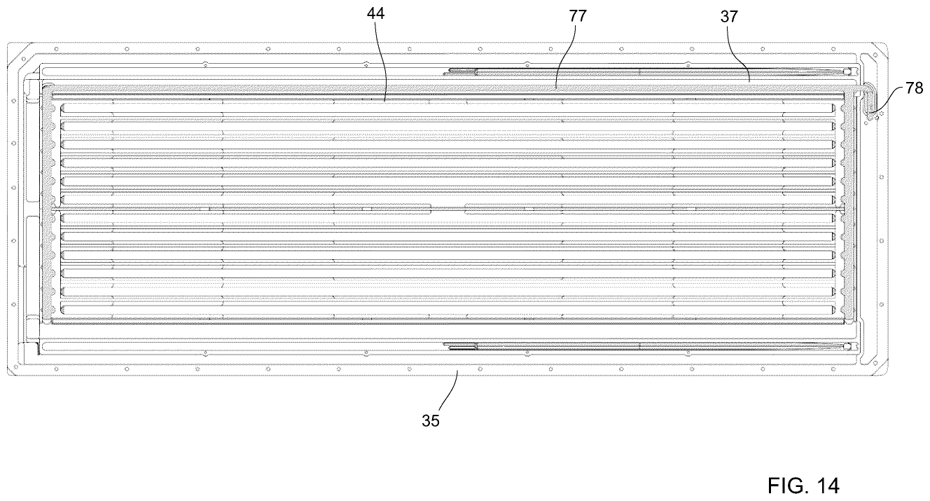

The fluid intake conduits 73 of the recirculation intake combs 72 are in fluid communication with a series of feeder conduits 74 (see FIG. 13), which conduct the liquid electrolyte 2 downward (arrowed flow paths) to main conduits 75, the main conduits 75 extending longitudinally within the base 35 along each longitudinal side of the discharge cathode assembly 31 to open into recirculation outlets 76 in an end of the base 35. Fluid directors 79 are employed to direct the liquid electrolyte through the feeder conduits 74. Further, in some embodiments, because there is leakage of liquid electrolyte 2 past the air cathode 34 into the gas volume 50, the floor 37 of the base 35 is provided with a drain channel 77 (see FIG. 14) and the floor 37 is sloped to guide leaked liquid electrolyte to the drain channel 77. The drain channel 77 directs the leaked liquid electrolyte to a drain port 78 in an end of the base 35.

Overall, it is advantageous that the electrolyte management subsystem 70 draws liquid electrolyte 2 substantially uniformly from all portions of the separator 41.

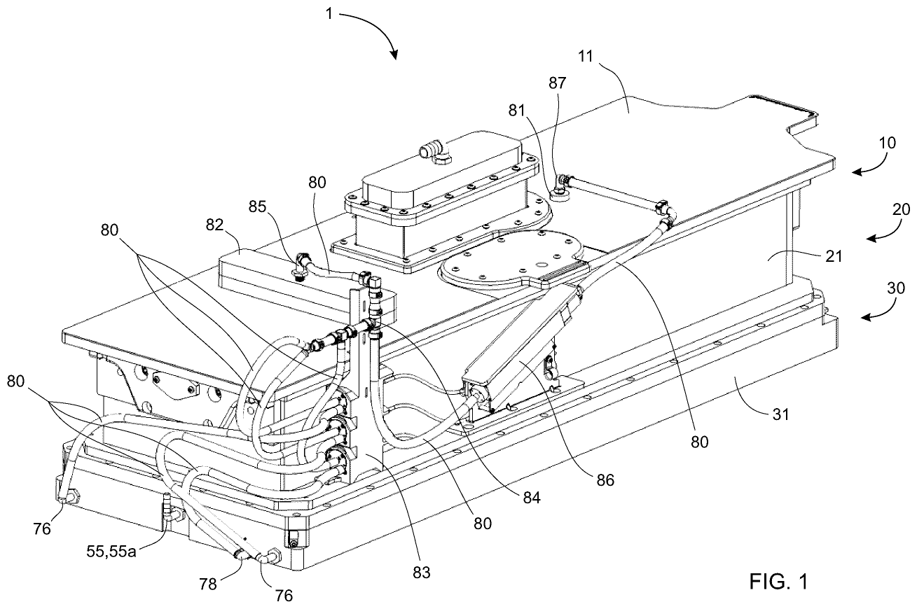

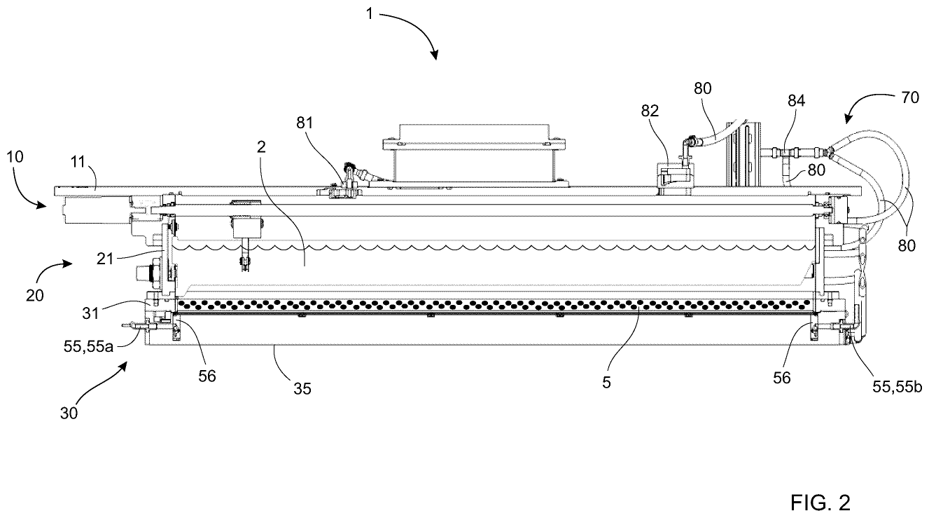

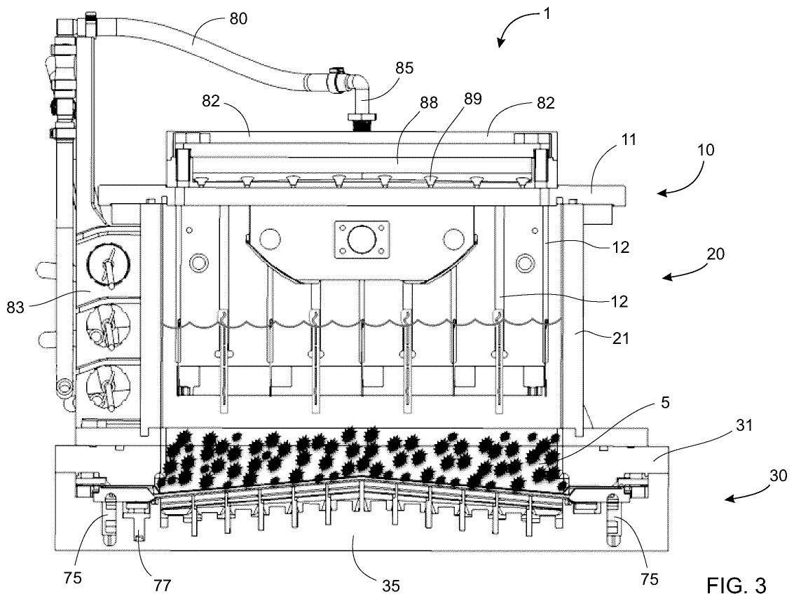

With specific reference to FIG. 1, FIG. 2 and FIG. 3, the electrolyte management subsystem 70 also comprises tubing 80 for directing recycled liquid electrolyte from the recirculation outlets 76 and the drain port 78 to a front rain head 81 and a rear rain head 82 on top of lid 11 where the recycled liquid electrolyte can be sprayed back into the electrochemical cell 1 at a top of the liquid electrolyte 2 reservoir. Tubing 80 from the recirculation outlets 76 and the drain port 78 are connected to a recirculation pump 83, which pumps the recycled liquid electrolyte through more tubing 80 connecting the recirculation pump 83 to a T-joint 84. At the T-joint 84, flow of the recycled liquid electrolyte is split, some recycled liquid electrolyte being directed through another tube to a rear rain head inlet 85 of the rear rain head 82 to be sprayed back into the electrochemical cell 1. Remaining recycled liquid electrolyte being directed through another tube to a concentration sensor 86 for monitoring the concentration of the recycled liquid electrolyte. From the concentration sensor 86, the remaining recycled liquid electrolyte is directed through another tube to a front rain head inlet 87 of the front rain head 81 to be sprayed back into the electrochemical cell 1. As seen in FIG. 3, the rear rain head 82 comprises a head space 88 that is filled with recycled liquid electrolyte, which rains down into the electrochemical cell 1 through a plurality of openings 89 in a bottom of the head space 88.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. An electrochemical cell comprising:
an anode comprising a solid anode material;
a liquid electrolyte in physical contact with the solid anode material;
an air cathode comprising a gaseous oxygen (O₂) cathode material, the air cathode oriented at an angle of 45° or less with respect to horizontal when in use in the cell;
an air cathode subassembly configured to house the gaseous oxygen in a gas volume, the air cathode sealingly mounted in the air cathode subassembly and separating the gas volume from the liquid electrolyte above the gas volume, the gaseous oxygen capable of diffusing out of the gas volume into an interface region of the air cathode where the gaseous oxygen contacts the liquid electrolyte;
a separator comprising an electrically insulating material, the separator separating the air cathode from the anode material, the separator permeable to the liquid electrolyte, the separator impermeable to the solid anode material; and,
an electrolyte management subsystem comprising at least one fluid conduit that collects the liquid electrolyte from between the air cathode and the separator and recirculates the collected electrolyte to the liquid electrolyte above the separator.

2. The cell of claim 1, wherein the air cathode subassembly comprises at least one recirculation outlet, and wherein the at least one fluid conduit comprises a plurality of internal fluid conduits in the air cathode subassembly in fluid communication with the liquid electrolyte between the air cathode and the separator, the plurality of internal fluid conduits having a plurality of recirculation inlets situated between the air cathode and the separator for collecting the liquid electrolyte from along edges of the air cathode and directing the collected liquid electrolyte to the at least one recirculation outlet through which the liquid electrolyte exits the air cathode subassembly.

3. The cell of claim 2, wherein the electrolyte management subsystem comprises at least one external fluid conduit in fluid communication with the at least one recirculation outlet and at least one fluid pump operatively connected to the at least one external fluid conduit for pumping the collected liquid electrolyte through and out of the at least one external fluid conduit into the cell above the separator.

4. The cell of claim 1, wherein the air cathode and the separator are peaked to minimize sagging of the air cathode and the separator and to promote flow of the liquid electrolyte toward outer edges of the separator.

5. The cell of claim 4, wherein the air cathode subassembly comprises a plurality of bridges situated in the gas volume to support the air cathode thereon.

6. The cell of claim 1, wherein the separator has a perimeter that is perimetrically sealed to the air cathode subassembly to prevent the solid anode material from entering the electrolyte management subsystem and so that the liquid electrolyte must permeate through the separator to reach the interface region.

7. The cell of claim 1, wherein the separator covers the air cathode to prevent anode material from directly contacting the air cathode.

8. The cell of claim 1, wherein the separator has a porosity that creates a pressure differential between above and below the separator to encourage more uniform permeation of the liquid electrolyte through the separator toward the air cathode across an entire surface area of the separator.

9. The cell of claim 1, wherein the anode comprises a bed of particles of the anode material covering the separator.

10. The cell of claim 1, wherein the anode material comprises zinc metal.

11. The cell of claim 1, wherein the anode further comprises a conductive metal anode current collector situated below and in physical contact with the anode material.

12. The cell of claim 1, wherein the electrolyte comprises an aqueous solution of hydroxide ions.

13. The cell of claim 1, wherein the housing comprises at least one gas port for introducing the gaseous oxygen into the gas volume.

14. The cell of claim 1, wherein the air cathode subassembly is configured to sealingly support walls thereon for containing the liquid electrolyte above the separator.

15. The cell of claim 1, wherein the cell is a charge/discharge type electrochemical cell.

16. A cathode assembly for an electrochemical cell, the cathode assembly comprising:
an air cathode subassembly configured to house a gaseous oxygen (O₂) cathode material in a gas volume, the air cathode subassembly comprising:
a frame bounding edges of the gas volume;
a floor bounding a first face of the gas volume;
at least one recirculation outlet in the air cathode subassembly; and,
a plurality of internal fluid conduits contained in the frame configured to collect liquid electrolyte from outside the gas volume to direct the collected liquid electrolyte to the at least one recirculation outlet through which the liquid electrolyte exits the air cathode subassembly; and,
an air cathode secured to the frame to bound a second face of the gas volume, the plurality of internal fluid conduits configured to collect the liquid electrolyte along edges of the air cathode.

17. The cathode assembly of claim 16, wherein the air cathode subassembly comprises a plurality of recirculation inlets situated along the edges of the air cathode, the plurality of recirculation inlets collecting the liquid electrolyte from outside the gas volume.

18. The cathode assembly of claim 16, wherein the air cathode subassembly comprises a base defining the floor and the frame, and the cathode assembly comprises a flange removably connected to a top of the base, the flange configured to support walls for containing liquid electrolyte in the electrochemical cell.

19. The cathode assembly of any one of claims 16 to 18, wherein the air cathode subassembly comprises at least one drain port, and wherein the floor is configured to direct liquid electrolyte that leaks into the gas volume toward the at least one drain port.

20. The cathode assembly of any one of claims 16 to 19, wherein the air cathode is peaked to minimize sagging of the air cathode.

21. The cathode assembly of claim 20, wherein the air cathode subassembly comprises a plurality of bridges situated in the gas volume to support the air cathode thereon.
